(19) United States
(12) Patent Application Publication
(10) Pub. No.: US 2012/0303967 A1
(43) Pub. Date: Nov. 29, 2012

(54) DIGITAL RIGHTS MANAGEMENT SYSTEM AND METHOD FOR PROTECTING DIGITAL CONTENT

(75) Inventors: Yen-Tsung Chia, Taoyuan Hsien (TW); Yu-Min Lin, Taoyuan Hsien (TW); Chih-Chung Hsu, Taoyuan Hsien (TW)

(73) Assignee: DELTA ELECTRONICS, INC., Taoyuan Hsien (TW)

(21) Appl. No.: 13/115,788

(22) Filed: May 25, 2011

(51) Int. Cl. G06F 12/14

(52) U.S. Cl. 713/189

(57) ABSTRACT

A digital content management system operative in a distributed network includes a SDP server and a client. The SDP server includes a content issuer and a right issuer. The content issuer is configured to randomly generate a first key, convert the first key to a second key by a conversion function, and encrypt a portion of a digital content item with the second key to form an encrypted portion, wherein the encrypted portion has its corresponding character code. The right issuer is configured to generate a right object, which includes the first key, and encrypt the right object.

### FIELD OF THE INVENTION

The present invention relates to a digital rights management system and method, and more particularly to a digital rights management system and method for protecting digital content with an obfuscation encryption and decryption mechanism.

### BACKGROUND OF THE INVENTION

Digital content has gained wide acceptance in the public. However, a large amount of cost, labor and time are needed to produce the digital content. Thus, when the digital content is copied and distributed without permission, a digital content provider may lose profit, and enthusiasm of creation may be discouraged. As a result, the development of digital content business may be obstructed. In order to reduce unauthorized copying and/or access to the digital content, various digital rights management (DRM) specifications have been developed.

DRM system is a mechanism that enables the consumption by users of protected digital content by allowing the content providers to express permissions for and/or constraints on the digital content. Presently, DRM specifications are being developed with respect to the distribution of content and services over wireless communication networks. One of the above-mentioned standards is being developed by the Open Mobile Alliance (OMA). FIG. 1 is a DRM system in accordance with the Open Mobile Alliance Standard version 2.0; and FIG. 2 is a diagram illustrating an encryption and authentication procedure according to the DRM system of FIG. 1. First, the Content Issuer 11 (CI) encrypts the original digital content, which is provided from the content provider, with a symmetric cryptograph algorithm such as Advanced Encryption Standard (AES). The original digital content is packaged into a DCF-formatted Content Object (CO) 110 and sent to the mobile device 21 of the content user. The content object 110 doesn't include the cryptograph encryption key. Second, the DRM agent 211 of the mobile device 21 contacts the Right Issuer (RI) 12 to get the Right Object (RO) 120, which is generated and managed by the right issuer 12 and contains a key 1201, a contract 1202, properties 1203 and a certificate 1204. When the content user intends to share the digital content files with other, the Certificate Authority (CA) 13, who issues and verifies the certificate management message 130, helps the right issuer 12 and the mobile device 21 of the content user to authenticate with each other. The right issuer 12 enciphers the right object 120 with a user's public key (not shown herein); then uses the message digest method to get the hash value and signs the right object 120 with a RI's private key (not shown herein). After receiving the right object 120, the mobile device 21 of the content user checks the message signature with the RI's public key (not shown herein) and decrypts the right object 121 with the user's public key (not shown herein). Third, the content user gets the content message digest and symmetric encryption key 1201 from right object 120. Then the mobile device 21 uses the symmetric encryption key 1201 to decrypt the content object 110 and compares the message digest with the content so as to make sure it has not been changed. The DRM agent 211 will record the rights constraint from the right object 120 and control how the digital content can be used accordingly.

However, the conventional DRM architecture is complex and still has the possibility that the hackers figure out the algorithm employed to encrypt the digital content. In addition, the literature-based digital content includes multiple portions, for example multiple chapters. The multiple portions of the digital content cannot be protected separately and deliberately by the conventional DRM system such that when any portion of the digital content is hacked, the rest portions of the content are also hacked accordingly. Moreover, once the DRM mechanism is hacked, anyone can access predetermined portions of the literature-based digital content without resistance.

In addition, the content object and right object are delivered separately and asynchronously to the content user by the OMA DRM system so that the end user can't access and read the digital content offline. Reading is considered as a relatively static activity and should not necessitate constant internet connection that consumes a high amount of electricity. Furthermore, the OMA's concept is to make sure the original content is not changed. However, the user might take some notes or annotations on the content that they are reading, in which case the original content will definitely be altered. The conventional DRM mechanism can't allow the content user to change the original content. Accordingly, there exists a need in the art to develop a DRM system for securely, effectively and flexibly managing, processing and protecting the digital content.

### SUMMARY OF THE INVENTION

It is an object of the present invention to provide a DRM system and method, which can enhance the security of the protection mechanism and minimize the possibility where once the DRM mechanism is hacked anyone can access predetermined portions of the digital content item without any resistance.

It is another object of the present invention to provide a DRM system and method, which can protect multiple portions of the digital content separately and deliberately such that when any portion of the digital content is hacked, the rest portions of the digital content can't be hacked easily.

It is a further object of the present invention to provide a DRM system and method with obfuscation encryption and decryption mechanism.

It is a further object of the present invention to provide a DRM system and method, which adopts the concept of synchronous delivery of content object and right object jointly or separately so as to support user's offline reading behavior.

It is a further object of the present invention to a DRM system for securely, effectively and flexibly managing, processing and protecting the digital content.

In accordance with one aspect of the present invention, a digital content management system operative in a distributed network includes a service delivery platform (SDP) server and a client. The service delivery platform server includes a content issuer and a right issuer. The content issuer is configured to randomly generate a first key, convert the first key to a second key by a conversion function, and encrypt a portion of a digital content item with the second key to form an encrypted portion, wherein the encrypted portion has its corresponding character code. The right issuer is configured to generate a right object, which includes the first key, and encrypt the right object. The client includes a device and a mediator. The mediator is configured for facilitating the device to authenticate with the right issuer and initiating the delivery of the encrypted portion and the encrypted right object from the SDP server to the mediator. The mediator includes an index table with a relationship between the character code and the conversion function. The mediator decrypts the encrypted right object with an attribute of the device for extracting the first key, identifies the character code from the encrypted portion, identifies the corresponding conversion function from the index table by using the character code, identifies the second key in accordance with the first key and the corresponding conversion function and decrypts the encrypted portion with the second key.

In accordance with another aspect of the present invention, a digital content management system operative in a distributed network includes a service delivery platform (SDP) server and a client. The service delivery platform server includes a content issuer and a right issuer. The content issuer is configured to randomly generate a first key, convert the first key to a second key by a conversion function, and encrypt a portion of a digital content item with the second key to form an encrypted portion, wherein the encrypted portion has its corresponding character code. The right issuer is configured to generate a right object, which includes the first key, and encrypt the right object. The client includes a device including a viewer, and a mediator. The mediator is configured for facilitating the device to authenticate with the right issuer and initiating delivery of the encrypted portion and the encrypted right object from the SDP server to the device. The viewer includes an index table with a relationship between the character code and the conversion function. The viewer decrypts the encrypted right object with an attribute of the device for extracting the first key, identifies the character code from the encrypted portion, identifies the corresponding conversion function from the index table by using the character code, identifies the second key in accordance with the first key and the corresponding conversion function and decrypts the encrypted portion with the second key.

In accordance with a further aspect of the present invention, a service delivery platform (SDP) server operative in a distributed network includes a content issuer and a right issuer. The content issuer is configured to randomly generate a first key, convert the first key to a second key by a conversion function, and encrypt a portion of a digital content item with the second key to form an encrypted portion, wherein the encrypted portion has its corresponding character code. The right issuer is configured to generate a right object, which includes the first key, and encrypt the right object.

In accordance with a further aspect of the present invention, a digital rights management method comprises: receiving from a source a request to access at least a portion of a digital content item; responsive to the request, randomly generating a first key, converting the first key to a second key by a conversion function, and encrypting the portion with the second key to form an encrypted portion, wherein the encrypted portion has its corresponding character code; generating a right object including the first key; encrypting the right object; and delivering the encrypted portion of the digital content item and the encrypted right object to the source, wherein authentication of the source facilitates decryption of the encrypted right object so as to enable the user to access the portion of the digital content item.

In accordance with a further aspect of the present invention, a method for accessing digital content item comprises: sending a request to access a portion of a digital content item, wherein the request randomly generates a first key, converts the first key to a second key by a conversion function, and encrypts the portion with the second key to form an encrypted portion, wherein the encrypted portion has its corresponding character code, wherein the request generates a right object with the first key and encrypts the right object; and receiving the encrypted portion and the encrypted right object.

In accordance with a further aspect of the present invention, a digital rights management method comprises: sending an attribute of the source for authentication; sending a request by a source to access a portion of a digital content item, wherein the request randomly generates a first key, converts the first key to a second key by a conversion function, and encrypts the portion with the second key to form an encrypted portion, wherein the encrypted portion has its corresponding character code, wherein the request generates a right object with the first key, and encrypts the right object; and receiving the encrypted portion and the encrypted right object by the source, wherein the authenticated source includes an index table with a relationship between the character code and the conversion function, wherein the authenticated source decrypts the encrypted right object in accordance with an attribute of the source for extracting the first key, identifies the character code from the encrypted portion, identifies the corresponding conversion function from the index table by using the character code, identifies the second key in accordance with the first key and the corresponding conversion function and decrypts the encrypted portion with the second key.

In accordance with a further aspect of the present invention, a method for accessing digital content item comprises: receiving an encrypted portion of a digital content item, wherein a first key is randomly generated, the first key is converted to a second key by a conversion function, and the portion is encrypted with the second key to form an encrypted portion, wherein the encrypted portion has its corresponding character code; and receiving an encrypted right object including the first key.

In accordance with a further aspect of the present invention, a digital rights management method comprises: receiving by a source an encrypted portion of a digital content item, wherein a first key is randomly generated, the first key is converted to a second key by a conversion function, and the portion is encrypted with the second key to form an encrypted portion, wherein the encrypted portion has its corresponding character code; and receiving by the source an encrypted right object including the first key and the encrypted portion, wherein the authenticated source includes an index table with a relationship between the character code and the conversion function, wherein the authenticated source decrypts the encrypted right object for extracting the first key, identifies the character code from the encrypted portion, identifies the corresponding conversion function from the index table by using the character code, identifies the second key in accordance with the first key and the corresponding conversion function and decrypts the encrypted portion with the second key.

### BRIEF DESCRIPTION OF THE DRAWINGS

FIG. 1 is a DRM system in accordance with the Open Mobile Alliance Standard version 2.0;

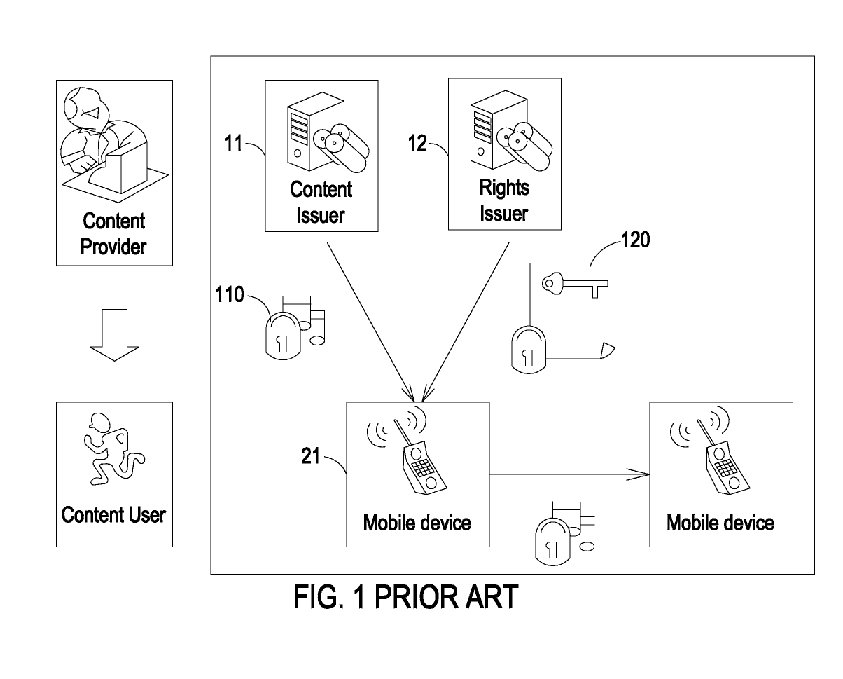

FIG. 2 is a diagram illustrating an encryption and authentication procedure according to the DRM system of FIG. 1;

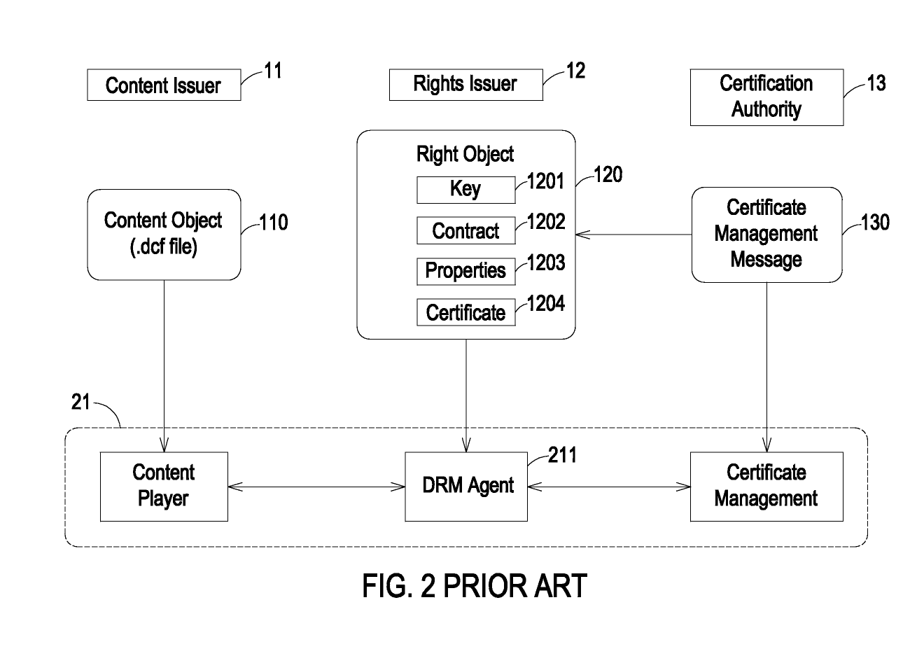

FIG. 3 is a DRM system operative in a distributed network in accordance with one preferred embodiment of the present invention;

FIG. 4 is a diagram illustrating the content transformation, encryption and delivery mechanism of the content issuer and the right issuer according to the DRM system of FIG. 3;

FIG. 5 is a detailed diagram of the DRM system of FIG. 3;

FIG. 6 is a flowchart of a digital right management method performed by the DRM system of FIG. 5;

FIG. 7 is a flowchart of the content transformation and encryption method performed by the content issuer according to the DRM system of FIG. 5;

FIG. 8 is a flowchart of the content transformation, encryption and delivery method performed by the SDP server according to the DRM system of FIG. 5; and

FIG. 9 is a flowchart showing a method of accessing the digital content item by the client according to the DRM system of FIG. 5.

### DESCRIPTION OF THE PREFERRED EMBODIMENT

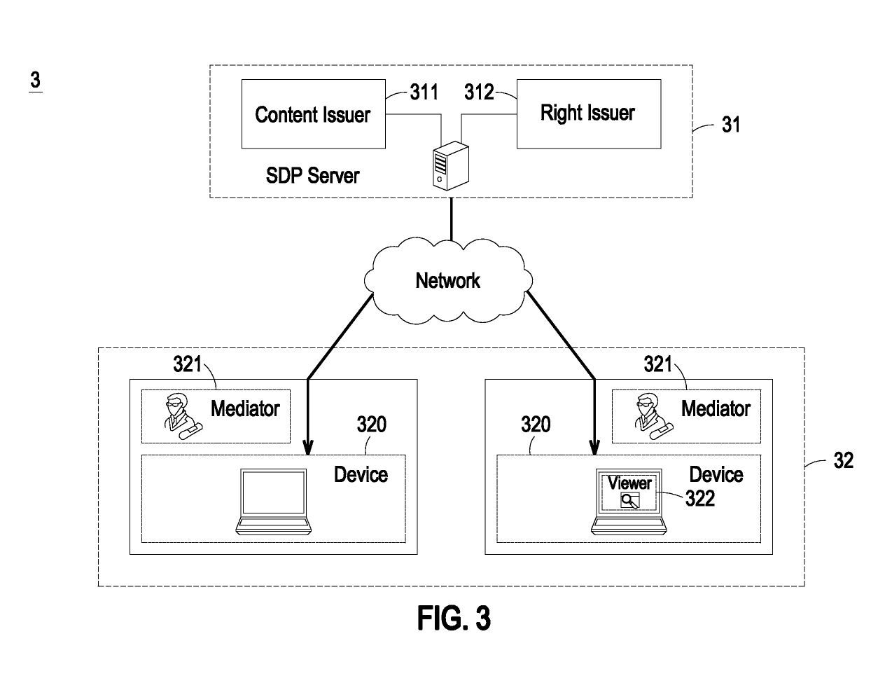

FIG. 3 is a DRM system operative in a distributed network in accordance with one preferred embodiment of the present invention. The DRM system 3 operative in a distributed network includes a service delivery platform (SDP) server 31 and at least one client 32. The SDP server 31 is configured to deliver or distribute the protected digital content item to the client 32 through the distributed network according to the management of the DRM system. The protected digital content item may include any type of digital content item known in the art, for example e-book, digital photograph, music clip, and the like. The distributed network includes a wired network, wireless network, or any combination of wired and wireless network. For example, the distributed network may include one or more of a local area network (LAN), wireless LAN (WLAN), cellular network, or any combination of such networks. Generally, the distributed network facilitates communication between the SDP server 31 and the client 32. The SDP server 31 includes a content issuer 311 and a right issuer 312. The content issuer 311 and the right issuer 312 may include plural servers operative in the distributed network. Alternatively, those skilled in the art will appreciate that the content issuer 311 and the right issuer 312 may be logically separate parts of a single server.

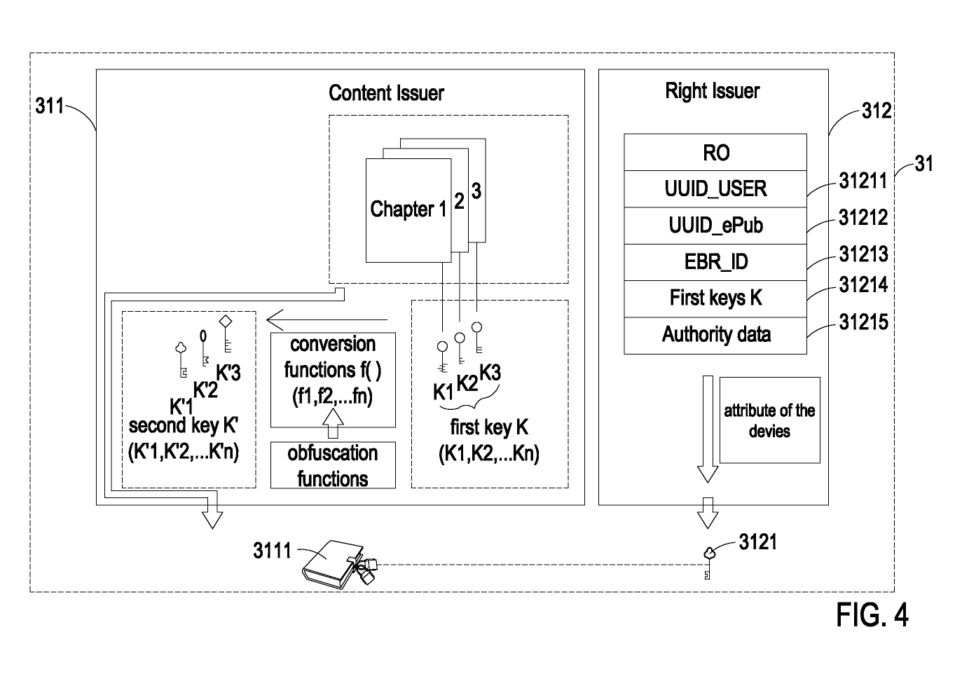

FIG. 4 is a diagram illustrating the content transformation, encryption and delivery mechanism of the content issuer and the right issuer according to the DRM system of FIG. 3. The content issuer 311 is configured to randomly generate a first key K for a portion (for example one chapter) of the digital content item, convert the first key K to a second key K′ by a conversion function f( ) selected among a plurality of obfuscation functions, and encrypt the portion of the digital content item with the second key K′ to form encrypted portion 3111, wherein the encrypted portion 3111 has its corresponding character code, for example a corresponding serial number. The right issuer 312 is configured to gather information and generate a right object 3121, which includes the first key K for the corresponding portion of the digital content item, and encrypt the right object 3121 with an attribute of the device of the client 32 to form the encrypted right object 3121.

Please refer to FIGS. 3 and 4 again. The client 32 includes a device 320 (for example personal computer, portable computer, tablet computer or e-book reader) and a mediator 321. The mediator 321 is configured for facilitating the device 320 to authenticate with the right issuer 312 of the SDP server 31 and initiating delivery of the encrypted portion 3111 and the encrypted right object 3121 from the SDP server 31 to the device 320 of the client 32. In some embodiment, the mediator 321 includes an index table with a relationship between the character codes and the conversion functions f( ). The function program of the mediator 321 includes the index table and can be updated by the SDP server 31 via the distributed network periodically and continuously. The mediator 321 can decrypt the encrypted right object 3121 with the attribute of the device 320 for extracting the first key K. The mediator 321 can identify the character code from the encrypted portion 3111, identify the corresponding conversion function from the index table by using the character code, identify the second key K′ in accordance with the first key and the corresponding conversion function and decrypt the encrypted portion 3111 with the second key K′ so that the portion of the digital content item can be viewed.

Alternatively, the client 32 includes a mediator 321 and a device 320 including a viewer 322. The mediator 321 is configured for facilitating the device 320 to authenticate with the right issuer 312 and initiating delivery of the encrypted portion 3111 and the encrypted right object 3121 from the SDP server 31 to the device 320 of the client 32. The viewer 322 includes an index table with a relationship between the character codes and the conversion functions f( ). The function program of the viewer 322 includes the index table and can be updated by the SDP server 31 via the distributed network periodically and continuously. The viewer 322 can decrypt the encrypted right object 3121 with an attribute of the device 320 for extracting the first key K. The view 322 can identify the character code from the encrypted portion 3111, identify the corresponding conversion function from the index table by using the character code, identify the second key K′ in accordance with the first key and the corresponding conversion function and decrypt the encrypted portion 3111 with the second key K′ so that the portion of the digital content item can be viewed.

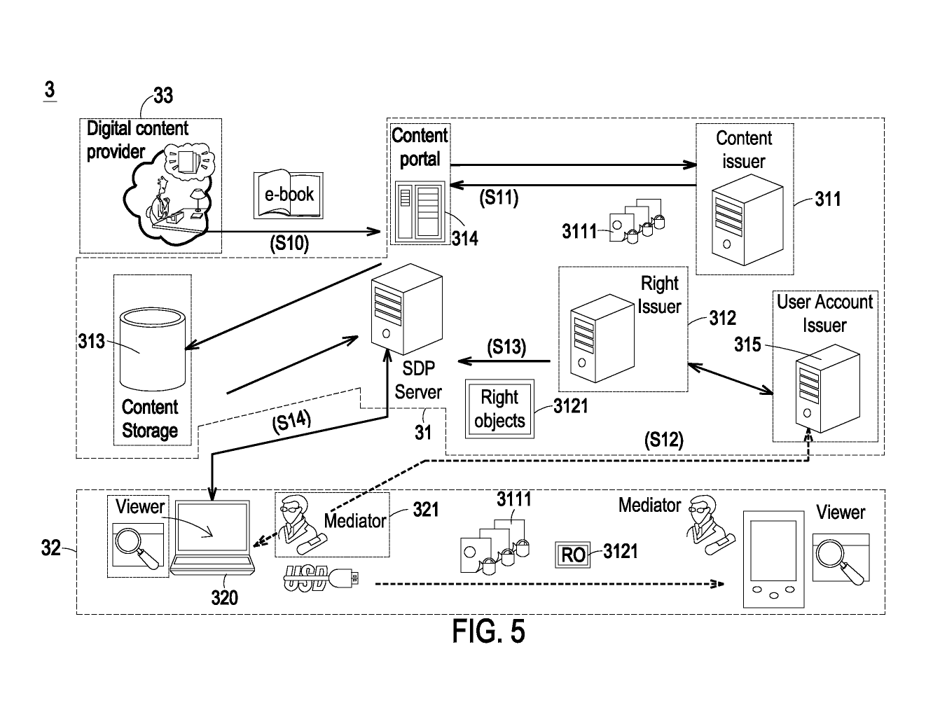

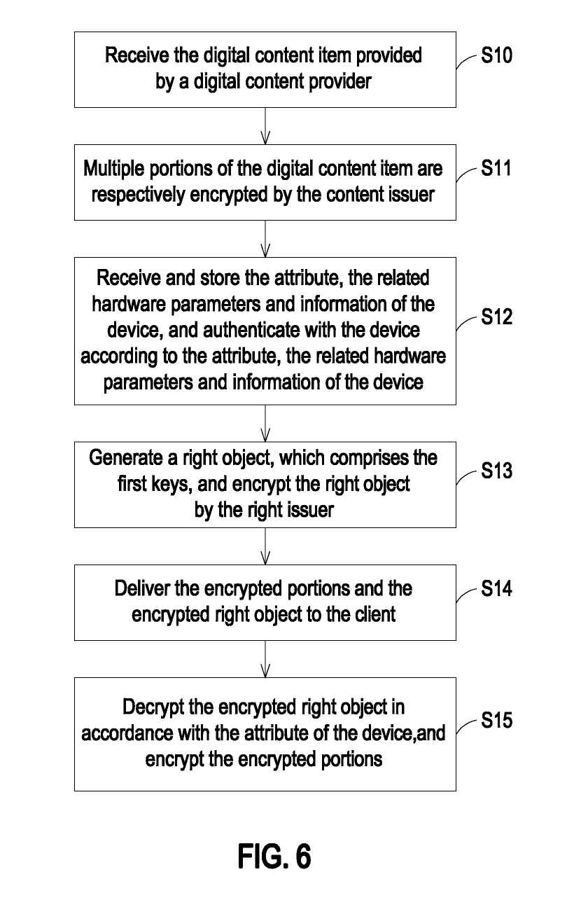

FIG. 5 is a detailed diagram of the DRM system of FIG. 3; and FIG. 6 is a flowchart of a digital right management method performed by the DRM system of FIG. 5. First, at the step S10, the digital content item such as e-book is uploaded to the content portal 314 of the SDP server 31 by a digital content provider 33. After the completeness, accuracy and related value-added service of the uploaded digital content item are checked by the content issuer 311, at the step S11, the digital content item is encrypted by the content issuer 311 with a symmetric cryptograph algorithm such as Advanced Encryption Standard (AES) immediately. At this step, the content issuer 311 uses AES to encrypt every portion (for example every chapter) of the digital content item to form encrypted portions 3111. After the encryption, every encrypted portion of the digital content item will have its corresponding character code.

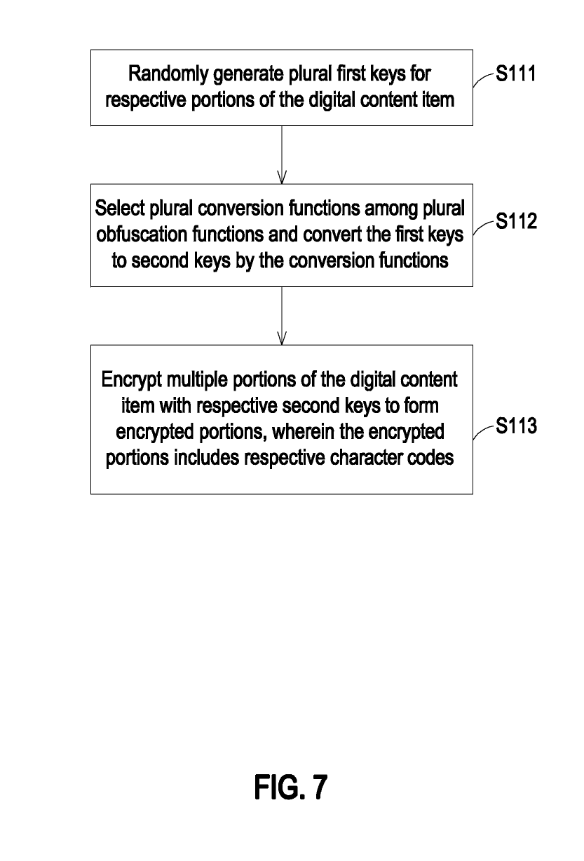

FIG. 7 is a flowchart of the content transformation and encryption method performed by the content issuer according to the DRM system of FIG. 5. When every portion of the digital content item is encrypted by the content issuer 311, the encryption method comprises the following steps. First, at the step S111, the content issuer 311 can randomly generate plural first keys K1, K2, K3, . . . Kn for respective portions (for example the first chapter, the second chapter, third chapter, . . . , the nth chapter) of the digital content item by random number generator, in which n is a positive integer. Then, at the step S112, the content issuer 311 selects a plurality of conversion functions f1( ), f2( ), f3( ), . . . fn( ) among a plurality of obfuscation functions and converts the first keys K1, K2, K3, . . . Kn for respective portions of the digital content item to plural second keys K1′, K2′, K3′, . . . Kn′ by respective conversion functions f1( ), f2( ), f3( ), . . . fn( ). Thereafter, at the step S113, the content issuer 311 encrypts the every portion of the digital content item with respective second key K′ to form encrypted portions 3111 (i.e. content object), wherein the encrypted portions 3111 include respective character codes. The content issuer 311 will store the keys, related parameters and character codes of the portions during the encryption process. Then, the encrypted portions of the digital content item such as encrypted chapters of the e-book will be delivered to and stored in the content storage 313 of the system.

Please refer to FIGS. 5 and 6 again. The client 31 can employ the mediator 321 to submit a registration request to the user account issuer 315 of the SDP server 31 for requesting to register at least one of plural user accounts. At the step S12, the mediator 321 can upload the attribute, the related hardware parameters and information of the device 320 to the content storage 313 via the user account issuer 315, and the content storage 313 will store the attribute, the related hardware parameters and information therein. The SDP server 31 can authenticate with the device 320 of the client 32 according to the attribute, the related hardware parameters and information stored in the content storage 313.

Before the SDP server 31 provides the protected digital content item to the client 32, at the step S13, the right issuer 312 can gather information and generate a right object 3121, which includes the first keys K. In some embodiment, the right object 3121 includes user Universally Unique Identifier (UUID_user) 31211, ePub Universally Unique Identifier (UUID_ePub) 31212, e-Book Reader ID 31213, first keys K 31214, and authority data 31215. The authority data 31215 may include various permissions associated with particular portions of protected digital content item, such as whether or not the content can be displayed or executed by the device of the client, as well as the number of times or the length of time the content can be displayed or executed. In addition, the various permissions with respect to the particular portions of the protected digital content item can also be selected from a group including viewing, editing, printing and annotating. Then, the right issuer 312 encrypts the right object 3121 by employing the attribute of the device so as to generate encrypted right object 3121. Thereafter, at the step S14, the SDP server 31 performs a synchronous delivery of the encrypted portions 3111 of the digital content item and the encrypted right object 3121 separately or jointly to the device 320 of the client 32 in response to the request submitted by the mediator 321. When the encrypted portions 3111 of the digital content item and the encrypted right object 3121 are delivered to the device 320 of the client 32, at the step S15, the mediator 321 or the viewer 322 of the device 320 decrypts the encrypted right object 3121 in accordance with the attribute of the device 320 for extracting the first keys K, and then the mediator 321 or the viewer 322 of the device 320 identifies the character codes from the encrypted portions 3111, identifies the corresponding conversion functions from the index table by using the character codes, identifies the second keys K′ in accordance with the first keys K and the corresponding conversion functions, and decrypts the encrypted portions 3111 with the respective second keys K′ so that the portions of the digital content item can be viewed.

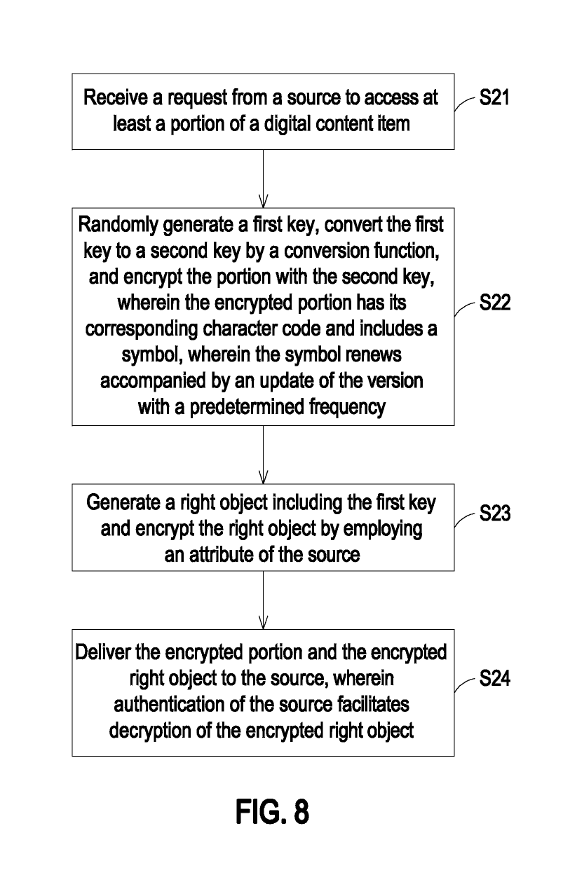

FIG. 8 is a flowchart of the content transformation, encryption and delivery method performed by the SDP server according to the DRM system of FIG. 5. First, at the step S21, the SDP server 31 receives a request from a source such as the mediator 321 of the client 32 to access at least a portion of a digital content item. At the step S22, in response to the request, the object issuer 311 of SDP server 31 randomly generates a first key K, converts the first key K to a second key K′, and encrypts the portion with the second key K′, wherein the encrypted portion 3111 has its corresponding character code. The encrypted portion 3111 further includes a symbol of a version, wherein the symbol renews accompanied by an update of the version with a predetermined frequency. Then, at the step S23, the right issuer 312 of the SDP server 31 generates a right object 3121 including the first key K. Thereafter, the right issuer 312 of the SDP server 31 encrypts the right object 3121 by employing an attribute of the device 320. Finally, at the step S24, the SDP server 31 delivers the encrypted portion 3111 of the digital content item and the encrypted right object 3121 to the source, wherein authentication of the source facilitates decryption of the encrypted right object 3121 so as to enable the end user to access the portion of the digital content item.

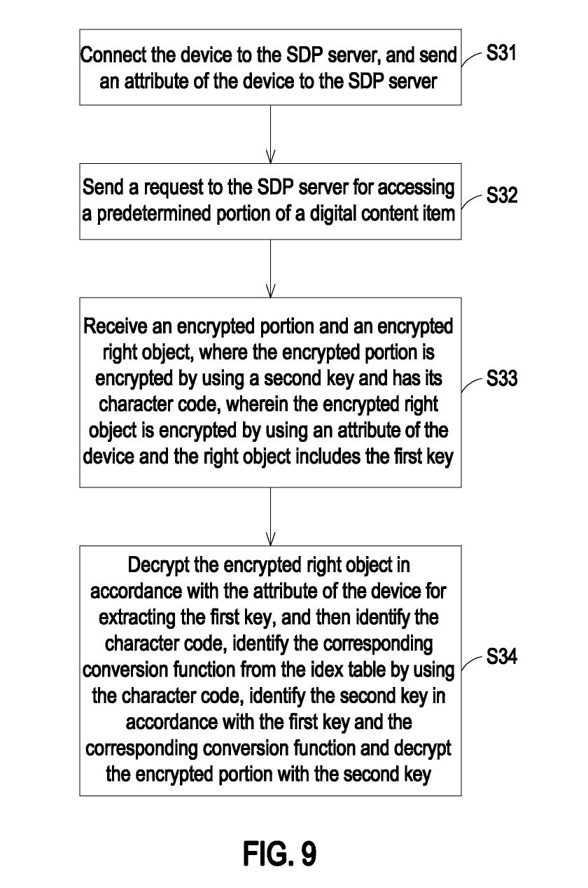

FIG. 9 is a flowchart showing a method of accessing the digital content item by the client according to the DRM system of FIG. 5. As shown in FIGS. 5 and 9, when the user would like to purchase or access a predetermined portion of a digital content item, the mediator 321 is executed and requests the user to enter the user account and password for connecting the device 320 of the client 32 to the SDP server 31. Then, at the step S31, the mediator 321 sends an attribute of the device 320 to the SDP server 31 for authentication and the device 320 is connected to the SDP server 31 via the mediator 321. Thereafter, at the step S32, the mediator 321 sends a request to the SDP server 31 for purchasing or accessing a predetermined portion of a digital content item. The right issuer of the SDP server 31 generates a right object 3121 including the first key K, and encrypts the right object 3121 by employing an attribute of the device 320 so as to generate encrypted right object 3121 in response to the request. Then, at the step S33, the device 320 receives the encrypted portion 3111 and the encrypted right object 3121 form the SDP server 31 via the mediator 321. Finally, at the step S34, the mediator 321 or the view 322 of the device 320 decrypts the encrypted right object 3121 according to the attribute of the device 320 for extracting the first key K, and then the mediator 321 or the viewer 322 of the device 320 identifies the character code from the encrypted portion 3111, identifies the corresponding conversion function from the index table by using the character code, identifies the second key K′ in accordance with the first key K and the corresponding conversion function and decrypts the encrypted portion 3111 with the second key K′ so that the portion of the digital content item can be viewed.

The decryption method performed by the mediator 321 or the viewer 322 of the device 320 is briefly described as follows. First, when the user would like to read the content of a predetermined portion of the digital content item, which is included in the ePub file, the mediator 321 or the viewer 322 of the device 320 is executed for opening the ePub file. Then, the mediator 321 or the viewer 322 of the device 32 checks whether or not the ePub file contains the encrypted right object 3121. If the ePub file contains the encrypted right object 3121, the mediator 321 or the viewer 322 of the device 320 employs the attribute of the device 320 to decrypt the encrypted right object 3121. Then, the mediator 321 or the viewer 322 of the device 320 decrypts the encrypted right object 3121 and extracts the first key K from the decrypted right object 3121. Thereafter, the mediator 321 or the viewer 322 of the device 320 checks whether or not the ePub file contains the encrypted portion 3111. If the ePub file contains the encrypted portion 3111, the mediator 321 or the viewer 322 of the device 320 identifies the character code from the header of the encrypted portion 3111. The mediator 321 or the viewer 322 of the device 320 includes an index table with the relationship between the character codes and the conversion functions f( ). Then, the mediator 321 or the viewer 322 of the device 320 identifies the corresponding conversion function from the index table by using the character code, identifies the second key K′ in accordance with the first key K and the corresponding conversion function and decrypts the encrypted portion 3111 with the second key K′ so that the portion of the digital content item can be viewed by the user.

To sum up, the present invention provides a DRM system and method, which can enhance the security of the protection mechanism and minimize the possibility where once the DRM mechanism is hacked anyone can access predetermined portions of the digital content item without any resistance. In addition, the DRM system and method of the present invention can protect multiple portions of the digital content separately and deliberately such that when any portion of the digital content is hacked, the rest portions of the digital content can't be hacked easily. Furthermore, the DRM system and method of the present invention uses an obfuscation encryption and decryption mechanism for protecting the digital content item. The DRM system and method of the present invention adopts the concept of synchronous delivery of content object and right object jointly or separately so as to support user's offline reading behavior. Accordingly, the DRM system and method of the present invention can manage, process and protect the digital content securely, effectively and flexibly.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A digital content management system operative in a distributed network, the digital content management system comprising:
a service delivery platform server, which comprises:
a content issuer configured for randomly generating a first key, converting the first key to a second key by a conversion function, and encrypting a portion of a digital content item with the second key to form an encrypted portion, wherein the encrypted portion has its corresponding character code; and
a right issuer configured for generating a right object, which comprises the first key, and encrypting the right object; and
a client, which comprises:
a device, and
a mediator configured for facilitating the device to authenticate with the right issuer and initiating delivery of the encrypted portion and the encrypted right object from the service delivery platform server to the mediator, wherein the mediator includes an index table with a relationship between the character code and the conversion function, wherein the mediator decrypts the encrypted right object with an attribute of the device for extracting the first key, identifies the character code from the encrypted portion, identifies the corresponding conversion function from the index table by using the character code, identifies the second key in accordance with the first key and the corresponding conversion function and decrypts the encrypted portion with the second key.

2. The digital content management system according to claim 1, wherein the mediator sends the attribute of the device to the service delivery platform server, and the right issuer encrypts the right object with the attribute of the device.

3. The digital content management system according to claim 1, wherein the service delivery platform server is configured to perform a synchronous delivery of the encrypted portion and the encrypted right object to the device of the client.

4. The digital content management system according to claim 1, wherein the right object includes at least one permission with respect to the portion of the digital content item, wherein the at least one permission is selected from a group including viewing, editing, printing and annotating.

5. A digital content management system operative in a distributed network, the digital content management comprising:
a service delivery platform server, which comprises:
a content issuer configured for randomly generating a first key, converting the first key to a second key by a conversion function, and encrypting a portion of a digital content item with the second key to form an encrypted portion, wherein the encrypted portion has its corresponding character code; and
a right issuer configured for generating a right object, which comprises the first key, and encrypting the right object; and
a client, which comprises:
a device comprising a viewer, and
a mediator configured for facilitating the device to authenticate with the right issuer and initiating delivery of the encrypted portion and the encrypted right object from the service delivery platform server to the device,
wherein the viewer includes an index table with a relationship between the character code and the conversion function, wherein the viewer decrypts the encrypted right object with an attribute of the device for extracting the first key, identifies the character code from the encrypted portion, identifies the corresponding conversion function from the index table by using the character code, identifies the second key in accordance with the first key and the corresponding conversion function and decrypts the encrypted portion with the second key.

6. The digital content management system according to claim 5, wherein the mediator sends the attribute of the device to the service delivery platform server, and the right issuer encrypts the right object with the attribute of the device.

7. The digital content management system according to claim 5, wherein the service delivery platform server is configured to perform a synchronous delivery of the encrypted portion and the encrypted right object to the device of the client.

8. The digital content management system according to claim 5, wherein the right object includes at least one permission with respect to the portion of the digital content item, wherein the at least one permission is selected from a group including viewing, editing, printing and annotating.

9. A service delivery platform server operative in a distributed network, the service delivery platform server comprising:
a content issuer configured for randomly generating a first key, converting the first key to a second key by a function, and encrypting a portion of a digital content item with the second key to form an encrypted portion, wherein the encrypted portion has its corresponding character code; and
a right issuer configured for generating a right object, which comprises the first key, and encrypting the right object.

10. The service delivery platform server according to claim 9, wherein the service delivery platform server is configured to perform a synchronous delivery of the encrypted portion and the encrypted right object to a device of a client.

11. The service delivery platform server according to claim 10, wherein the right issuer encrypts the right object with an attribute of the device.

12. A digital content management method, comprising:
receiving from a source a request to access at least a portion of a digital content item;
responsive to the request, randomly generating a first key, converting the first key to a second key by a conversion function, and encrypting the portion with the second key to form an encrypted portion, wherein the encrypted portion has its corresponding character code;
generating a right object comprising the first key;
encrypting the right object; and
delivering the encrypted portion of the digital content item and the encrypted right object to the source, wherein authentication of the source facilitates decryption of the encrypted right object so as to enable the user to access the portion of the digital content item.

13. The digital content management method according to claim 12, further comprising receiving an attribute of the source, and encrypting the right object with the attribute of the source.

14. The digital content management method according to claim 12, wherein an index table with a relationship between the character code and the conversion function is included in the source.

15. The digital content management system according to claim 12, wherein the encrypted portion and the encrypted right object are delivered to the source synchronously.

16. The digital content management system according to claim 12, wherein the encrypted portion includes a symbol of a version, wherein the symbol renews accompanied by an update of the version with a predetermined frequency.

17. A method for accessing digital content item, comprising:
sending a request to access a portion of a digital content item, wherein the request randomly generates a first key, converts the first key to a second key by a conversion function, and encrypts the portion with the second key to form an encrypted portion, wherein the encrypted portion has its corresponding character code, wherein the request generates a right object including the first key and encrypts the right object; and
receiving the encrypted portion and the encrypted right object.

18. A digital rights management method, comprising:
sending an attribute of a source for authentication;
sending a request by the source to access a portion of a digital content item, wherein the request randomly generates a first key, converts the first key to a second key by a conversion function, and encrypts the portion with the second key to form an encrypted portion, wherein the encrypted portion has its corresponding character code, wherein the request generates a right object with the first key and encrypts the right object; and
receiving the encrypted portion and the encrypted right object by the source, wherein the authenticated source includes an index table with a relationship between the character code and the conversion function, wherein the authenticated source decrypts the encrypted right object in accordance with an attribute of the source for extracting the first key, identifies the character code from the encrypted portion, identifies the corresponding conversion function from the index table by using the character code, identifies the second key in accordance with the first key and the corresponding conversion function and decrypts the encrypted portion with the second key.

19. A method for accessing digital content item, comprising:
receiving an encrypted portion of a digital content item, wherein a first key is randomly generated, the first key is converted to a second key by a conversion function, and the portion is encrypted with the second key to form an encrypted portion, wherein the encrypted portion has its corresponding character code; and
receiving an encrypted right object comprising the first key.

20. A digital content management method, comprising:
receiving by a source an encrypted portion of a digital content item, wherein a first key is randomly generated, the first key is converted to a second key by a conversion function, and the portion is encrypted with the second key to form an encrypted portion, wherein the encrypted portion has its corresponding character code; and
receiving by the source an encrypted right object comprising the first key and the encrypted portion, wherein the authenticated source includes an index table with a relationship between the character code and the conversion function, wherein the authenticated source decrypts the encrypted right object in accordance with an attribute of the source for extracting the first key, identifies the character code from the encrypted portion, identifies the corresponding conversion function from the index table by using the character code, identifies the second key in accordance with the first key and the corresponding conversion function and decrypts the encrypted portion with the second key.
